(19) United States
(12) Patent Application Publication
(10) Pub. No.: US 2011/0115795 A1
(43) Pub. Date: May 19, 2011

(54) Concentric Pie Chart Graphic for Simultaneously Conveying Multiple Types of Relationships

(75) Inventors: Robert Koch, San Francisco, CA (US); Udo Waibel, Los Altos, CA (US)

(73) Assignee: HARA SOFTWARE, INC., Redwood City, CA (US)

(21) Appl. No.: 12/748,279

(22) Filed: Mar. 26, 2010

(51) Int. Cl. G06T 11/20

(52) U.S. Cl. 345/440

(57) ABSTRACT

A method is described for generating a single graphic chart that illustrates relative quantities associated with different elements and relationships among the different elements. In one example, a processing system receives raw data, such as data for deriving the CO2e emissions per country. Assume a client wants to graphically illustrate both the relative quantities of emissions per country and the relative quantities of emissions per geographical region. The processing system creates an outer pie chart by arranging arc-sections, representing each country, so that the arc-sections associated with each geographic region are adjacent one another. The processing system then generates an inner pie chart, coaxial with the outer pie chart, illustrating the relative quantities of emissions per geographical region, wherein boundaries of each arc-section in the inner pie chart are aligned with boundaries of an associated grouping of related arc-sections in the outer pie chart.

### FIELD OF THE INVENTION

The present invention generally relates to the field of generating a graphic representation of relationships among elements, where the graphic representation is automatically generated by a programmed processing system. More specifically, the invention relates to a process for creating and displaying a variation of a pie chart.

### BACKGROUND

A pie chart is a conventional graphic used to convey the relative proportions of quantities associated with different elements. FIG. 1 is an example of a conventional pie chart 6. Each element is represented by an arc-section 7-10 of a circular pie, where the sum of all arc-sections equals 360°. All arc-sections 7-10 taper towards the center of the pie chart 6 and meet at the center. Pie charts may be automatically generated by a software program, where the user enters raw data identifying absolute quantities associated with each element to be represented. The software then generates a pie chart, where each arc-section is a different color and spans an arc proportional to its actual quantity. Typically, the arrangement of the arc-sections making up the pie chart is arbitrary, not critical, not relevant, and not specified by the user.

In some situations, it would be helpful to also know other proportions related to the elements, based on other criteria, where quantities associated with these other proportions are not directly entered by the user. Such other proportions may convey macro-proportions (created by grouping the individual elements) derived from the data entered by the user. In the past, the user must generate a separate pie chart for each relationship of interest, and the software creates the separate pie charts directly from the input data. It is then up to the user to visually compare the independently generated pie charts, side-by-side, to determine the interrelationships between the two or more separate pie charts. Since, typically, the arrangement of the arc-sections making up each pie chart is arbitrary, it is difficult for the user to fully grasp relationships between the two pie charts.

What is needed is an automated process for generating a graphic for a user to readily understand two or more different relationships between elements.

### SUMMARY

In one embodiment, one or more users enter raw data into a programmed computer system via an interface such as a keyboard, or the data may be entered automatically. Each user's computer display may then convey options to the user for graphically displaying processed information to the user relating to the data entered.

A specific example will be given to illustrate the invention. Assume the data entered by the users over a period of time is used to calculate the quantity of CO2e emissions, in tonnes, for each of the following countries: Mexico plus other Latin American countries, Japan, China, Korea, United States, Canada, Brazil and other South American countries, and France and other European countries. Assume a user of the system now wants to graphically see the relationships between the CO2e emissions of all of the countries. The user then navigates through menu driven displays using a mouse or other I/O interface to identify that the user wants the system to graphically display the relationships between the CO2e emissions of all of the countries. Assume the user also wants to see the proportions of the total CO2e emissions generated by each geographic region—Latin America, North America, Asia, and South America. The user then requests the system to also graphically display these relationships. Note that the users had not tagged the data to each geographic region when entering the data, but only tagged the data to the individual countries.

The computer system then automatically generates a first pie chart showing relationships between the CO2e emissions of all of the countries. Based upon the information requested by the user, the system automatically arranges the countries of each geographic region adjacently in the first pie chart. The system then generates a second but smaller pie chart that shows the proportion of the total CO2e emissions generated by each geographic region. The two pie charts are overlaid to be coaxial, with the first (outer) pie chart being effectively behind and larger than the second (inner) pie chart. The pie charts are created by the system so that the Latin American segment of the second pie chart precisely aligns with the outer borders of the group of Latin American countries in the first pie chart, the South American segment precisely aligns with the outer borders of the group of South American countries in the first pie chart, and so on.

The interrelationships of the two pie charts are readily understood by the user, due to the coordinated arrangements of the arc-sections in both pie charts. Therefore, there is synergy in the arrangement and coaxial positioning of the two pie charts.

In another embodiment, the pie chart showing the relationships is the outer pie chart, and the pie chart showing the proportions for the individual elements is the inner pie chart. However, since the proportions for the individual elements will create a more crowded pie chart, it is preferred that the pie chart identifying the proportions for the individual elements be the outer pie chart.

The user may position a curser over any segment of the pie charts to see a pop up window conveying more detail about the segment.

There may be more than two coaxial pie charts to convey even higher level relationships between the elements in the second pie chart.

Any information may be conveyed by the multiple coaxial pie charts.

The creation of the coaxial pie charts is performed by a programmed processing system, which may be a single microprocessor or a processing system including processors specifically programmed for displaying graphics.

### BRIEF DESCRIPTION OF THE DRAWINGS

FIG. 1 is an example of a conventional pie chart.

FIG. 2 schematically illustrates a centralized processing system that can receive inputs from a plurality of clients, via the Internet, and then generate graphics tools to assist the clients in understanding the relationships between elements, in accordance with one embodiment of the invention.

FIG. 3 is an example of a computer screen display showing concentric, coaxial pie charts that are generated by the processing system and displayed to the clients via a website to enable the clients to readily understand the relationships between elements. A legend identifying the sections of the pie charts is also displayed on the screen.

FIG. 4 is a flowchart of a method performed by the server of the processing system to generate the charts of FIG. 3.

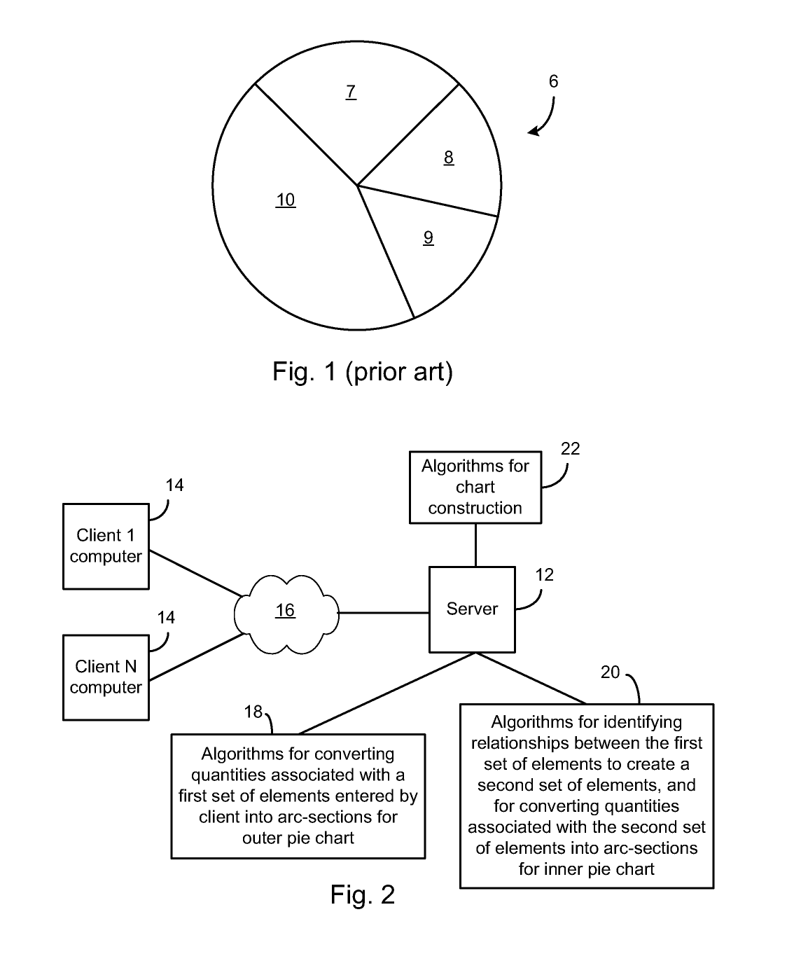

### DETAILED DESCRIPTION

FIG. 2 illustrates a centralized processing system usable by a plurality of clients. A server 12, managed by the host, provides a website that interfaces with the various clients (organizations) to allow the clients to upload data to the server 12 and view information generated by the server 12 relating to the data. The server 12 and the clients' computers 14, including display screens, communicate via a computer network, such as the Internet 16. A client accesses its account using passwords or other methods.

Although the server 12 has many functions, and there may be a plurality of servers, only one server and its software routines related to the present invention are illustrated. The programs illustrated are algorithms 18, 20, and 22, discussed in detail below.

There may be thousands of clients using the system. Each client can view its own results and, in some cases, data from all clients is combined for use by all clients.

The present invention applies to the graphical representation of any type of data involving quantities. Such data may be, for example, the quantity of CO2e emissions or energy usage by various countries, companies, facilities, etc. Any other data may be used with the invention.

The client may input available data into the system via a menu-driven website, or data may be entered from any other source, including data automatically entered.

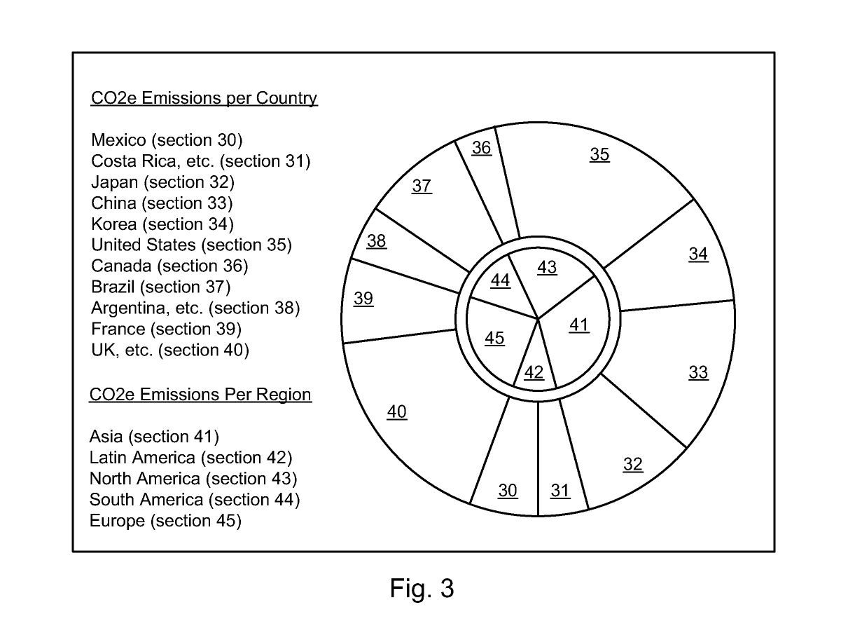

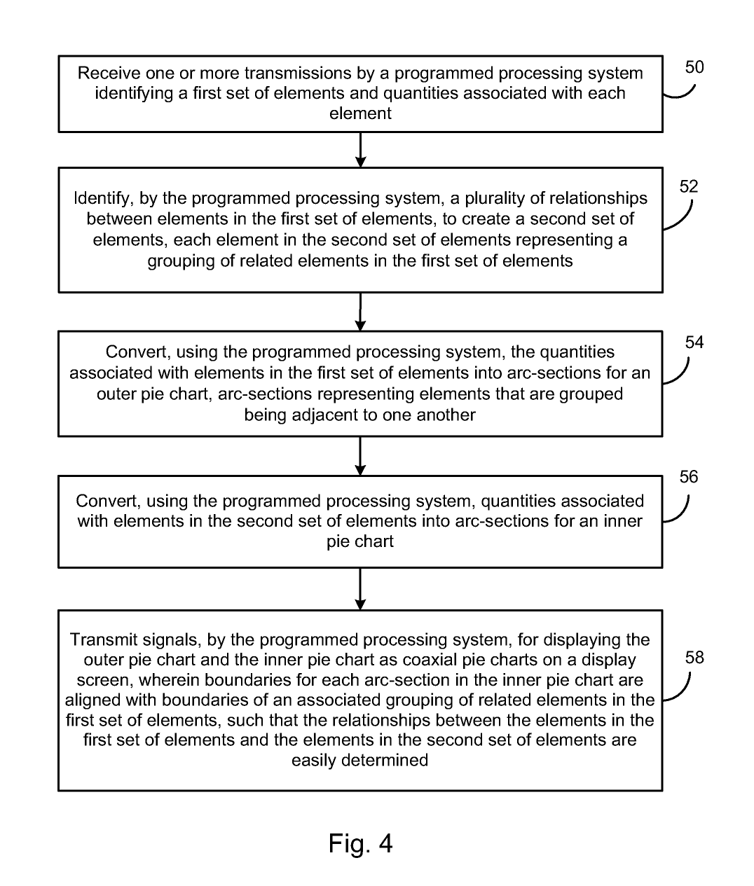

In the example used in FIGS. 3 and 4, the data is related to the quantity of CO2e emissions for various countries. The raw data uploaded to the server 12 may be the quantity, per country, of energy used, various gas emissions, waste products, water used, resources used, products produced, or any other data. In the example of determining each country's contributions to global warming, the data is then converted into its carbon-dioxide equivalent (CO2e) emissions (in tonnes) using publicly known conversion factors. The server 12 may perform the conversions, or the CO2e emissions per country may be uploaded to the server 12 as the raw data.

In describing the computer display of FIG. 3, the corresponding step in the flowchart of FIG. 4 will also be identified.

In the example, it is assumed that the data uploaded to the server 12 is used to identify the CO2e emission quantities (in tonnes) for the following countries. The section (an arc-section) of the chart of FIG. 3 associated with each country is also identified. Some countries in certain geographical regions are not specifically identified for simplicity, but are included in the term “etc.”

CO2e Emissions per Country

Mexico (section 30)

Costa Rica, etc. (section 31)

Japan (section 32)

China (section 33)

Korea (section 34)

United States (section 35)

Canada (section 36)

Brazil (section 37)

Argentina, etc. (section 38)

France (section 39)

UK, etc. (section 40)

In the more generic flowchart of FIG. 4, step 50 refers to the countries as a first set of elements, and the data used to identify the CO2e emissions is referred to as the quantities associated with each element.

It is also assumed that the client wishes to know the total CO2e emission for the following regions. The section of the chart of FIG. 3 associated with each region is also identified.

CO2e Emissions Per Region

Asia (section 41)

Latin America (section 42)

North America (section 43)

South America (section 44)

Europe (section 45)

Step 52 in FIG. 4 refers to the geographic regions as a second set of elements, representing relationships between elements in the first set of elements.

The server 12 then applies the algorithms 18 (FIG. 2) to convert the quantities of CO2e emissions for each country into arc-sections for an outer pie chart, where there is one arc-section per country. This step is broadly identified as step 54 in FIG. 4. Pie chart algorithms are well known, and those skilled in the art of programming would be able to adapt the well known pie chart algorithms to create the charts according to the present invention.

The server 12 creates the outer pie chart shown in FIG. 3 using sections 30-40. Each section 30-40 will typically be color coded or pattern coded to distinguish the sections, and there may be a legend next to the chart listing the countries with their corresponding section colors, equivalent to the listing of countries and section identifiers shown in FIG. 3. If a client moves a cursor over a section and clicks on it, more detail regarding that section, such as the country and quantity of CO2e emission, could be displayed in a pop-up window.

In the example of FIG. 3, the client identified to the server 12 that the client also wished to view the total CO2e emissions per geographical region, although the client did not upload data specifically tagged to each geographic region. More generally, the client specifies to the server 12 to further process the data to generate a graphic that conveys particular relationships between the elements in the outer pie chart. The designated relationships identify elements in the outer pie chart that are to be grouped together. These steps are identified as steps 54 and 56 in FIG. 4.

In the example of FIG. 3, the server 12 is pre-programmed with the identities of all the countries of the world and receives uploaded data sufficient to determine (e.g., calculate using conversion factors) the CO2e emissions for some or all of those countries. The server 12 also programmed with various default relationships between the countries, such as all countries in Latin America, Asia, Europe, South America, North America, Africa, etc. The server 12 may also be programmed with other relationships such as countries that have signed on to certain agreements relating to greenhouse gas emissions. A client may also provide customized criteria for the relationships.

The default relationships for the inner pie chart, identifying the groupings (sections 41-45), may be offered to the client in a menu-driven website, and the server 12 generates the coaxial pie charts in response to the client's selections. There may be many different relationships for the client to select from, and the server 12 will automatically arrange the sections in the outer pie chart based on the client's selection of a particular relationship (or grouping) so that all sections in a particular group are arranged to be adjacent one another in the outer pie chart. For example, using the same countries and emissions identified in FIG. 3 for the outer pie chart, the automatic arrangement of the sections 30-40 in the outer pie chart would be different if the client wanted the inner pie chart to group the countries in terms of gross domestic product (GDP) ranges, members of certain treaties, etc. Therefore, the server 12 automatically arranges the sections in the coaxial pie charts once the relationships in the inner pie chart are selected.

The same arc-sections in the outer pie chart may be automatically rearranged multiple times by the server 12 depending on the client changing the groupings (relationships) for the inner pie chart, and each composite chart may be separately displayed for comparison by the client.

As shown in step 58, once the coaxial pie charts are created (as a digital code representing the final pie chart graphic), the processing system transmits the code for displaying the coaxial pie charts on a display screen (FIG. 3), wherein boundaries for each arc-section (e.g., geographical region) in the inner pie chart are aligned with boundaries of an associated grouping of related elements (e.g., countries) in the first set of elements, such that the relationships between the elements in the first set of elements and the elements in the second set of elements are easily determined. For example, the boundary of the section 41 in FIG. 3, representing Asia, radially aligns with the outer boundary of the group of sections 32-34 representing the group of Japan, Korea, and China.

FIG. 3 shows that a small gap between the coaxial pie charts may be used to better distinguish them.

In some cases, an element in the outer pie chart may not be grouped with any other element in the outer pie chart.

When the website presents a list of countries to a client for uploading data or selecting countries for the chart, the listing may be in alphabetical order or another order not related to the arrangement of sections in the outer pie chart.

Any type of data may be graphically shown in the coaxial pie chart. For example, the elements in the outer pie chart may be CO2e emissions corresponding to each of the various types of resources used by the client and activities by the client that use resources, such as CO2e emissions due to gasoline usage, electricity usage, natural gas usage, airline travel, automobile travel, etc., where the total of all the CO2e emissions is the total CO2e emissions by the client (a company). The inner pie chart may group the elements by resources used and activities, so the client can see the effects of cutting down on resources used or activities.

In another example, the outer pie chart may include elements that represent energy usage from all forms of transportation used by employees of the client, and the inner pie chart may group the elements by ground and air transportation.

In another example, the outer pie chart may include elements that represent energy usage by different companies or different facilities in a company, and the inner pie chart may group the elements by types of companies or facilities (e.g., manufacturing vs. office).

The client may generate multiple related composite pie charts. One composite pie chart may represent the CO2e emissions by various facilities, and another composite pie chart may represent the resources used by the facilities (normalized to a single unit of measurement). In this way the emission efficiency for each facility can be determined. The charts may be generated for the entire company or individual facilities owned by the client. Many other types of data can be charted.

More than two coaxial pie charts may be displayed to convey two or more groupings of the elements in the different pie charts. An example of such a composite pie chart may convey revenue numbers of a certain company from large-area geographies (e.g., Americas, APA, EMEA, etc.) in the most inner pie chart, individual countries (e.g., USA, Canada, Mexico, Germany, Japan, France, etc.) in a middle pie chart, and regions within each country (e.g., California, Alaska, Texas, etc.) in the most outer pie chart. The arrangements of the arc-sections in each pie chart are automatically determined by the designated groupings so that the arc-sections in each grouping are adjacent.

Another composite pie chart may have information divided by geography (most inner pie chart), region (middle pie chart), and facility (most outer pie chart). Another composite pie chart may divide resource consumption by identifying the actual resources in the outer pie chart, and grouping the resources in one or more inner pie charts.

Additional information may be conveyed by the relative thicknesses (heights) of each arc-section. In such a case, the composite pie chart would be displayed using a perspective view to show the third dimension (height). The thickness of an arc-section could represent cost, regulatory risk, etc. associated with that arc-section.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A method for generating a single graphic chart that illustrates relative quantities associated with different elements and relationships among the different elements, the method comprising:
a. receiving one or more transmissions of data, the data conveying quantities associated with elements in a first set of elements;
b. processing the data, using a programmed processing system, to create an outer pie chart, the outer pie chart comprising arc-sections forming a circle, each arc-section corresponding to an element in the first set of element, where each arc-section has a size substantially proportional to a quantity associated with that arc-section;
c. additionally processing the data, using the programmed processing system, to create an inner pie chart, smaller than the outer pie chart and coaxial with the outer pie chart, the inner pie chart identifying groups, using arc-sections in the inner pie chart, of the elements represented by the arc-sections in the outer pie chart, based on certain criteria, the outer pie chart and inner pie chart being a composite pie chart,
wherein step b further comprises arranging the arc-sections in each group in the outer pie chart to be adjacent to one another, wherein boundaries of each arc-section in the inner pie chart are aligned with boundaries of an associated group of related elements in the outer pie chart; and
e. transmitting the composite pie chart for viewing on a display screen.

2. The method of claim 1 wherein the elements in the first set of elements are selected from elements comprising countries, types of usages of energy, companies, or facilities.

3. The method of claim 1 wherein the quantities associated with the elements in the first set of elements are quantities used to calculate emissions by each element.

4. The method of claim 3 wherein the emissions are in quantities of CO2e emissions.

5. The method of claim 3 wherein step b further comprises processing the data to calculate a quantity of CO2e emissions for each element based on the data received in step a.

6. The method of claim 1 further comprising creating an additional pie chart that is smaller than the inner pie chart and coaxial with the inner pie chart and outer pie chart, the additional pie chart grouping arc-sections in the inner pie chart in accordance with particular relationships between the arc-sections in the inner pie chart.

7. The method of claim 1 wherein the arc-sections in the outer pie chart are different colors.

8. The method of claim 1 where there is a gap between the inner pie chart and the outer pie chart.

9. The method of claim 1 where a quantity represented by each arc-section in the inner chart is a sum of quantities represented in an associated grouping of arc-sections in the outer pie chart.

10. The method of claim 1 wherein one or more elements in the outer pie chart are not grouped with any other elements in the inner pie chart.

11. The method of claim 1 further comprising changing the certain criteria for the groups of the elements represented by the arc-sections in the outer pie chart, wherein step b further comprises rearranging the arc-sections in the outer pie chart, by the programmed processing system, to form changed groups of adjacent arc-sections due to the certain criteria being changed.

12. A programmed server for generating a single graphic chart that illustrates relative quantities associated with different elements and relationships among the different elements, the server being programmed for performing the method comprising:
a. receiving one or more transmissions of data, the data conveying quantities associated with elements in a first set of elements;
b. processing the data, using a programmed processing system, to create an outer pie chart, the outer pie chart comprising arc-sections forming a circle, each arc-section corresponding to an element in the first set of element, where each arc-section has a size substantially proportional to a quantity associated with that arc-section;
c. additionally processing the data, using the programmed processing system, to create an inner pie chart, smaller than the outer pie chart and coaxial with the outer pie chart, the inner pie chart identifying groups, using arc-sections in the inner pie chart, of the elements represented by the arc-sections in the outer pie chart, based on certain criteria, the outer pie chart and inner pie chart being a composite pie chart,
wherein step b further comprises arranging the arc-sections in each group in the outer pie chart to be adjacent to one another, wherein boundaries of each arc-section in the inner pie chart are aligned with boundaries of an associated group of related elements in the outer pie chart; and
e. transmitting the composite pie chart for viewing on a display screen.

13. The server of claim 12 wherein a quantity represented by each arc-section in the inner chart is a sum of quantities represented in an associated grouping of arc-sections in the outer pie chart.

14. The server of claim 12 wherein one or more elements in the outer pie chart are not grouped with any other elements in the inner pie chart.

15. A computer readable media including program instructions which when executed by a processing system cause the processing system to perform a method for generating a single graphic chart that illustrates relative quantities associated with different elements and relationships among the different elements, the method comprising:
a. receiving one or more transmissions of data, the data conveying quantities associated with elements in a first set of elements;
b. processing the data, using a programmed processing system, to create an outer pie chart, the outer pie chart comprising arc-sections forming a circle, each arc-section corresponding to an element in the first set of element, where each arc-section has a size substantially proportional to a quantity associated with that arc-section;
c. additionally processing the data, using the programmed processing system, to create an inner pie chart, smaller than the outer pie chart and coaxial with the outer pie chart, the inner pie chart identifying groups, using arc-sections in the inner pie chart, of the elements represented by the arc-sections in the outer pie chart, based on certain criteria, the outer pie chart and inner pie chart being a composite pie chart,
wherein step b further comprises arranging the arc-sections in each group in the outer pie chart to be adjacent to one another, wherein boundaries of each arc-section in the inner pie chart are aligned with boundaries of an associated group of related elements in the outer pie chart; and
e. transmitting the composite pie chart for viewing on a display screen.

16. The media of claim 15 wherein a quantity represented by each arc-section in the inner chart is a sum of quantities represented in an associated grouping of arc-sections in the outer pie chart.

17. The media of claim 15 wherein one or more elements in the outer pie chart are not grouped with any other elements in the inner pie chart.
